(19) United States
(12) Patent Application Publication
(10) Pub. No.: US 2020/0053468 A1
(43) Pub. Date: Feb. 13, 2020

(54) SPEAKER

(71) Applicant: AAC Technologies Pte. Ltd., Singapore city (SG)

(72) Inventor: Xiaojiang Gu, Shenzhen (CN)

(21) Appl. No.: 16/529,829

(22) Filed: Aug. 2, 2019

(30) Foreign Application Priority Data
Aug. 13, 2018 (CN) 201821302299.6

(51) Int. Cl. H04R 7/16

(52) U.S. Cl. CPC H04R 7/16

(57) ABSTRACT

A speaker is provided. The speaker includes: a holder enclosed by a side wall; and a diaphragm supported by and fixed to the holder, the diaphragm being configured to vibrate and emit sound. The side wall is in a ring shape, and includes an inner side surface, an outer side surface, a bottom surface, a top surface, and an avoiding step. The outer side surface is opposite to the inner side surface. The bottom surface connects the inner side surface with the outer side surface. The top surface is opposite to the bottom surface. The diaphragm is fixed to the top surface. The avoiding step is formed by recessing from the top surface in a direction facing away from the diaphragm. The avoiding step is in a ring shape and is connected to the inner side surface or the outer side surface.

### TECHNICAL FIELD

The present disclosure relates to the field of electric-acoustic conversion technologies, and in particular, to a speaker applied to a portable electronic product.

### BACKGROUND

With the advent of the mobile interne era, a number of smart mobile devices continuously increase. Among many mobile devices, mobile phones are undoubtedly the most common and portable mobile terminal device. At present, mobile phones have extremely diverse functions, one of which is high-quality music. Therefore, speakers for playing sound are widely used in today's smart mobile devices.

In the related art, a speaker includes a holder, a vibration unit fixed to the holder, and a magnetic circuit unit driving the vibration unit to vibrate and emit sound. The vibration unit includes a diaphragm supported by and fixed to the holder.

However, in the speaker of the related art, since a die insert is inevitably spliced at a side of the holder close to the diaphragm, and the inner side or the outer side of the holder close to the diaphragm is prone to form burrs, so that bonding of the diaphragm may be affected, thereby affecting reliability of the speaker. Therefore, it is necessary to trim the burrs, thereby causing the frequent die repair problem due to burrs trimming in production and use, and seriously affecting production efficiency.

Therefore, it is necessary to provide a new speaker to solve the above technical problems.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a perspective structural schematic view of a speaker according to an embodiment of the present disclosure;

FIG. 2 is a perspective structural view of a part of a speaker according to an embodiment of the present disclosure;

FIG. 3 is a perspective structural view of a part of a holder of a speaker according to Embodiment 1 of the present disclosure;

FIG. 4 is a perspective structural view of a part of a holder of a speaker according to Embodiment 2 of the present disclosure; and

FIG. 5 is an enlarged view showing a region A in FIG. 4.

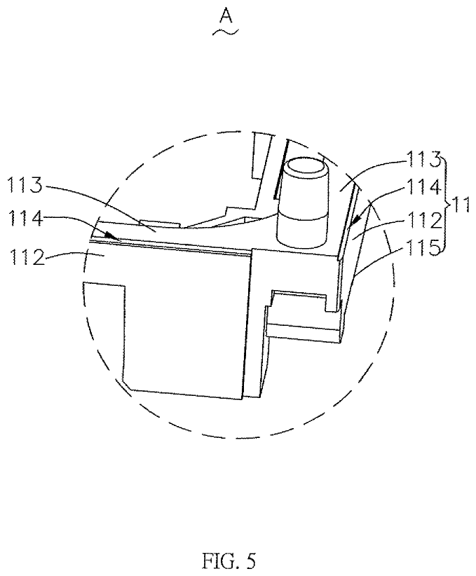

### DESCRIPTION OF EMBODIMENTS

The present disclosure will be further illustrated with reference to the accompanying drawings and the embodiments.

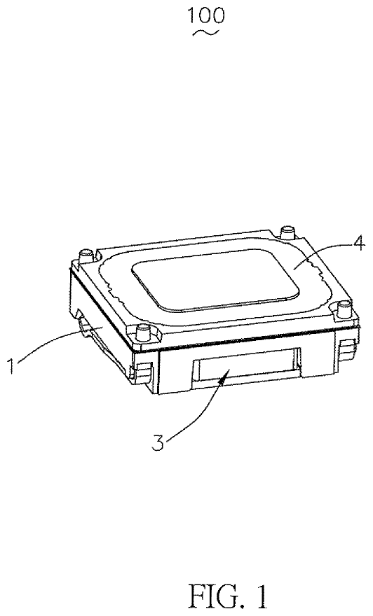

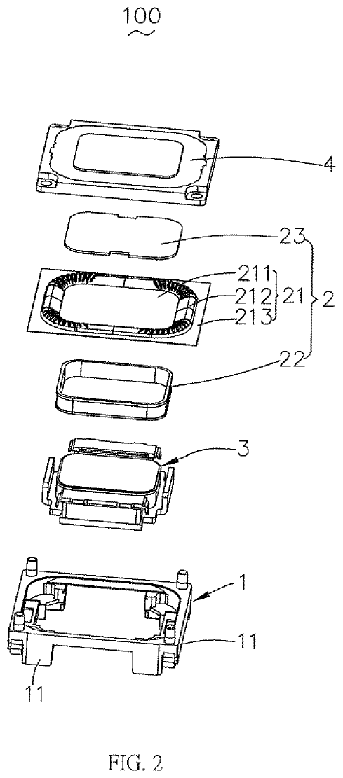

Referring to FIGS. 1-2, the present disclosure provides a speaker 100. The speaker 100 includes a holder 1, a vibration unit 2, a magnetic circuit unit 3, and a front cover 4. The vibration unit 2 includes a diaphragm 21.

The holder 1 is enclosed by a side wall 11. In this embodiment, the holder 1 has a rectangular structure. The structure of the holder 1 is not limited to being rectangular.

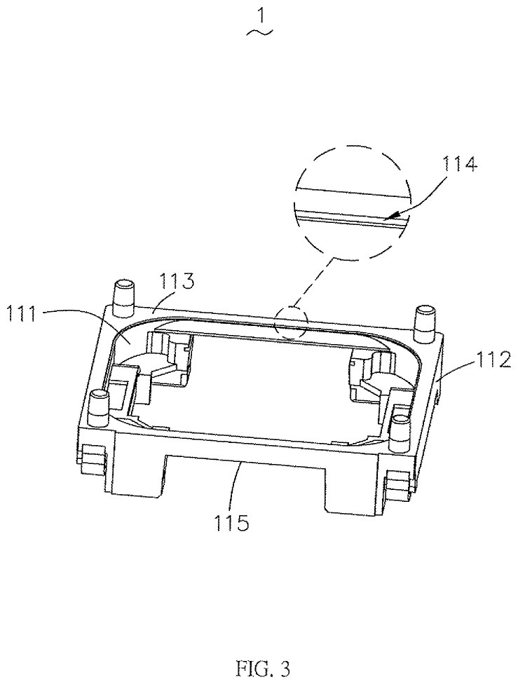

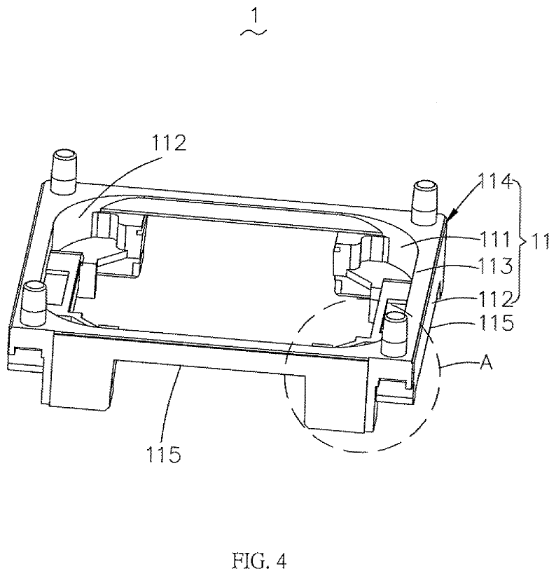

The side wall 11 is in a ring shape. Referring to FIGS. 3-4 in conjunction, the side wall 11 includes an inner side surface 111, an outer side surface 112, a bottom surface 115, a top surface, and an avoiding step 114. The outer side surface 112 is opposite to the inner side surface 111. The bottom surface 115 connects the inner side surface 111 with the outer side surface 112. The top surface 113 is opposite to the bottom surface 115. The avoiding step 114 is formed by recessing from the top surface 113 in a direction facing away from the diaphragm 21.

The diaphragm 21 is fixed to the top surface 113. The avoiding step 114 is in a ring shape and connected to the inner side surface 111 or the outer side surface 112. That is, the avoiding step 114 is provided at the inner side or the outer side of the top surface 113.

For example, as shown in FIG. 3, the avoiding step 114 is connected to the inner side surface 111. That is, the avoiding step 114 is provided at the inner side of the top surface 113.

As shown in FIG. 4, the avoiding step 114 is connected to the outer side surface 112. That is, the avoiding step 114 is provided at the outer side the top surface 113.

In the above structure, the burrs formed by the holder 1 are mainly located at the outer side or the inner side of the top surface 113, so that bonding of the diaphragm 21 may be affected. Therefore, the position where the avoiding step 114 is formed can avoid formation of the burrs, which would otherwise affect the diaphragm 21, thereby improving reliability of the speaker 100. On the other hand, the process of requiring multiple repairs due to burrs can be avoided, thereby effectively improving production efficiency of the speaker 100.

It should be noted that a position of the avoiding step 114 depends on the actual mosaic position of the die.

In one embodiment, the avoiding step 114 has a depth of 0.04 mm to 0.06 mm, preferably 0.05 mm, and a width of 0.04 mm to 0.06 mm, preferably 0.05 mm. The depth refers to a size from the top surface 113 in a direction facing away from the diaphragm 21. The width refers to a size in a direction from the outer side surface 112 to the inner side surface 111 or in a direction from the inner side surface 111 to the outer side surface 112.

In this embodiment, the avoiding step 114 is formed through injection molding. That is, when the holder 1 is being manufactured by injection molding, the side wall 11 is also formed by injection molding together with the avoiding step 114.

The vibration unit 2 is fixed to the holder 1. The vibration unit 2 includes a diaphragm 21, a voice coil 22 and a dome 23. The diaphragm 21 is fixed to the holder 1. The voice coil 22 drives the diaphragm 21 to vibrate and emit sound. The dome 23 is bonded and fixed to the diaphragm 21.

The diaphragm 21 is configured to vibrate and emit sound. The diaphragm 21 is bonded and fixed to the top surface 113 by means of gluing. In one embodiment, the diaphragm 21 includes a vibration portion 211, a suspension portion 212, and a fixed portion 213. The suspension portion 212 extends outwards from a periphery of the vibration portion 211. The fixed portion 213 extends in a direction from the suspension portion 212 to the holder 1 and is fixed to the holder 1. The fixed portion 213 is fixed to the top surface 113. That is, the fixed portion 213 is bonded and fixed to the top surface 113 by means of gluing.

The magnetic circuit unit 3 is fixed to the holder 1. The magnetic circuit unit 3 generates a magnetic field to drive the vibration unit 2 to vibrate and emit sound. That is, the magnetic circuit unit 3 generates a magnetic field to provide a driving force to the vibration unit 2.

The front cover 4 covers and is fixed to the holder 1. The front cover 4 presses the diaphragm 21.

Compared with the related art, with the speaker of the present disclosure, an avoiding step is provided at the inner side or the outer side of the top surface of the holder adjacent to the diaphragm. That is, the avoiding step is connected to the inner side or the outer side. When the diaphragm is fixedly glued to the holder, providing the avoiding step can avoid formation of burrs at the position, thereby avoiding influence on bonding of the diaphragm. Therefore, the speaker can have a better reliability. Meanwhile, the number of die repairs can be effectively reduced by avoiding formation of burrs, thereby improving production efficiency of the speaker.

The above are only preferred embodiments of the present disclosure. Here, it should be noted that those skilled in the art can make modifications without departing from the inventive concept of the present disclosure, but these shall fall into the protection scope of the present disclosure.

What is claimed is:

1. A speaker, comprising:
a holder enclosed by a side wall; and
a diaphragm supported by and fixed to the holder, the diaphragm being configured to vibrate and emit sound;
wherein the side wall is in a ring shape, and comprises an inner side surface, an outer side surface, a bottom surface, a top surface, and an avoiding step; the outer side surface is opposite to the inner side surface; the bottom surface connects the inner side surface with the outer side surface; the top surface is opposite to the bottom surface; the diaphragm is fixed to the top surface; the avoiding step is formed by recessing from the top surface in a direction facing away from the diaphragm, and the avoiding step is in a ring shape and is connected to the inner side surface or the outer side surface.

2. The speaker as described in claim 1, wherein the avoiding step has a depth of 0.04 mm to 0.06 mm and a width of 0.04 mm to 0.06 mm.

3. The speaker as described in claim 1, wherein the diaphragm comprises a vibration portion, a suspension portion extending outwards from a periphery of the vibration portion, and a fixed portion extending in a direction from the suspension portion to the holder and fixed to the holder, the fixed portion being fixed to the top surface.

4. The speaker as described in claim 3, wherein the diaphragm is bonded and fixed to the top surface by means of gluing.

5. The speaker as described in claim 3, wherein the avoiding step is formed by injection molding.
